(19) United States
(12) Patent Application Publication
(10) Pub. No.: US 2003/0156868 A1
(43) Pub. Date: Aug. 21, 2003

(54) Device for cleaning photosensitive drum of wet type printer

(75) Inventors: Hyun-Seong Shin, Seoul (KR); Geun-Yong Park, Gyunggi-do (KR); Yong-Su Kim, Gyunggi-do (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/243,672

(22) Filed: Sep. 16, 2002

(30) Foreign Application Priority Data
Feb. 15, 2002 (KR) 2002-8223

(51) Int. Cl. G03G 21/00

(52) U.S. Cl. 399/348

(57) ABSTRACT

A photosensitive drum cleaning device of a wet type printer includes: a cleaning blade disposed on a photosensitive drum to contact and wipe an outer circumference of the rotating photosensitive drum, for removing a developer that has not been transferred to a transfer belt but remains on the photosensitive drum; and a developer drain holder for collecting and discharging the developer removed by the cleaning blade. The cleaning blade includes first and second guide wings which are respectively formed at opposite sides of a contact portion of the cleaning blade and the photosensitive drum and which have a predetermined height. The guide wings prevent the developer that is wiped by the cleaning blade from streaming down over the opposite sides of the cleaning blade. The guide wings are formed integrally with the cleaning blade to have a width that is thinner than the thickness of the cleaning blade. Accordingly, due to the presence of the pair of guide wings, the residual developer wiped by the cleaning blade is prevented from streaming down over the opposite sides of cleaning blade.

### BACKGROUND OF THE INVENTION

1. Field of the Invention

The present invention relates to a wet type printer and, more particularly, to a device for cleaning a photosensitive drum of a wet type printer, which removes a developer that has not been transferred to a transfer belt but remains on the photosensitive drum.

2. Description of the Related Art

A general wet type electrophotographic printer comprises a photosensitive drum having a layer capable of being electrically charged, for generating an electric potential difference at a place charged by exposure to a light source, a charging device for charging the photosensitive drum, an exposure device for converting an electric signal of image data to an optical signal, projecting the converted signal to the photosensitive drum and forming a latent image by the electric potential difference, a developing device for developing the electric latent image of the photosensitive drum with a toner to form a visible image, a transfer device for transferring the visible image to a sheet of paper supplied from a paper feeding cassette, a fixing device for fixing the transferred visible image on the paper, and a photosensitive drum cleaning device for removing a developer which has not been transferred to the transfer device but remains on the photosensitive drum.

FIGS. 1 and 2 are views schematically showing such a wet type electrophotographic printer, wherein the reference numerals 10, 20, 30, 40 and 50 respectively indicate a photosensitive drum, a charging roller, a developing device, a transfer belt, and a photosensitive drum cleaning device.

As shown in FIGS. 1 and 2, the charging roller 20 is disposed on a side of the photosensitive drum 10, for charging the photosensitive drum 10. The developing device 30 comprises a developer receptacle 31 for containing a developer D therein, a developing roller 32 rotatably disposed in the developer receptacle 31 to contact the photosensitive drum 10, a depositing roller 34 being immersed in the developer D of the developer receptacle 31 and contacting or forming a gap with respect to the developing roller 32 to deposit the developer D on the developing roller 32 by an electric field force which is generated by voltage from a power supply device 33, a blade 35 for pressing the developing roller 32 with a predetermined pressure to adjust the thickness of the developer D deposited on the developing roller 32, and a cleaning roller 36 for removing a developer which is not used in the developing roller 32. The transfer belt 40 pressingly contacts the photosensitive drum 10 and moves in an arrowed direction as shown in FIG. 1 when the photosensitive drum 10 rotates. Accordingly, a visible image that is formed by the developer D on the photosensitive drum 10 is transferred to the transfer belt 40 and then retransferred from the transfer belt 40 to a sheet of paper.

The photosensitive drum cleaning device 50 removes a developer which has not been transferred to the transfer belt 40 but remains on the photosensitive drum 10 while the visible image is transferred to the transfer belt 40 with the developer D of the photosensitive drum 10. Accordingly, subsequent images are protected from the residual developer.

The photosensitive drum cleaning device 50 comprises a cleaning blade 51 and a developer drain holder 52. The cleaning blade 51 is disposed adjacent to a nip of the photosensitive drum 10 and the transfer belt 40 and contacts an outer circumference of the photosensitive drum 10, for removing the residual developer. The developer drain holder 52 collects and discharges the developer removed by the cleaning blade 51. At this point, the cleaning blade 51 has a thickness ranging approximately from 1 mm to 2 mm and has a length L2 that is longer than a length L1 of the photosensitive drum 10. The cleaning blade 51 is inclined at a predetermined angle with respect to the photosensitive drum 10. Accordingly, the cleaning blade 51 wipes the residual developer off from the photosensitive drum 10. The wiped developer flows over the cleaning blade 51 into the developer drain holder 52 and is finally discharged.

In the conventional photosensitive drum cleaning device as described above, the developer wiped by the cleaning blade 51 does not flow over the cleaning blade 51 into the developer drain holder 52 until the developer is accumulated to an extent that corresponds to the thickness of the cleaning blade 51. During the above process, however, there occurs a problem of the so-called “Wrap-around” that the developer streams down over both sides of the cleaning blade 51 (Refer to the arrows in FIG. 2) prior to being accumulated to the extent that corresponds to the thickness of the cleaning blade 51. The developer streaming down over both sides of the cleaning blade 51 contaminates the charging roller 20 and thus deteriorates charge uniformity of the photosensitive drum 10, thereby resulting in a problem of the so-called “Back ground”. Accordingly, there is a need for solving the “Wrap-around” problem.

### SUMMARY OF THE INVENTION

The present invention has been developed to solve the above-mentioned problem. Accordingly, it is an aspect of the present invention to provide a photosensitive drum cleaning device of a wet type printer capable of preventing the “Wrap-around” problem wherein a developer wiped off from a photosensitive drum by a cleaning blade streams down over both sides of the cleaning blade.

In order to achieve the above aspect, a photosensitive drum cleaning device of a wet type printer consistent with the present invention comprises: a cleaning blade which is operative to be disposed on a photosensitive drum to contact and wipe an outer circumference of the rotating photosensitive drum and which removes a developer that has not been transferred to a transfer belt but remains on the photosensitive drum; and a developer drain holder which collects and discharges the developer removed by the cleaning blade. The cleaning blade comprises first and second guide wings which are respectively formed at opposite sides of a contact portion of the cleaning blade and the photosensitive drum and which have a predetermined height. The first and second guide wings prevent the developer that is wiped by the cleaning blade from streaming down over the opposite sides of the cleaning blade.

The cleaning blade has a length identical to or shorter than a length of the photosensitive drum.

Also, each of the guide wings has a width that is thinner than the thickness of the cleaning blade.

According to the present invention, due to the presence of the pair of guide wings disposed at opposite sides of the cleaning blade that contact the photosensitive drum, the residual developer wiped by the cleaning blade is prevented from streaming down over opposite sides of cleaning blade. Accordingly, the contamination of the transfer belt, which is conventionally generated by the residual developer, is prevented.

### BRIEF DESCRIPTION OF THE DRAWINGS

The above aspect and characteristics of the present invention will be more apparent by describing an illustrative, non-limiting embodiment of the present invention in greater detail with reference to the accompanying drawings, in which:

FIG. 1 is a view schematically showing a photosensitive drum cleaning device of a conventional wet type printer;

FIG. 2 is a side section view of FIG. 1;

FIG. 3 is a view schematically showing a photosensitive drum cleaning device of a wet type printer according to an illustrative, non-limiting embodiment of the present invention;

FIG. 4 is a side section view of FIG. 3; and

FIG. 5 is a view showing a cleaning blade comprising a guide wing as an aspect of the present invention.

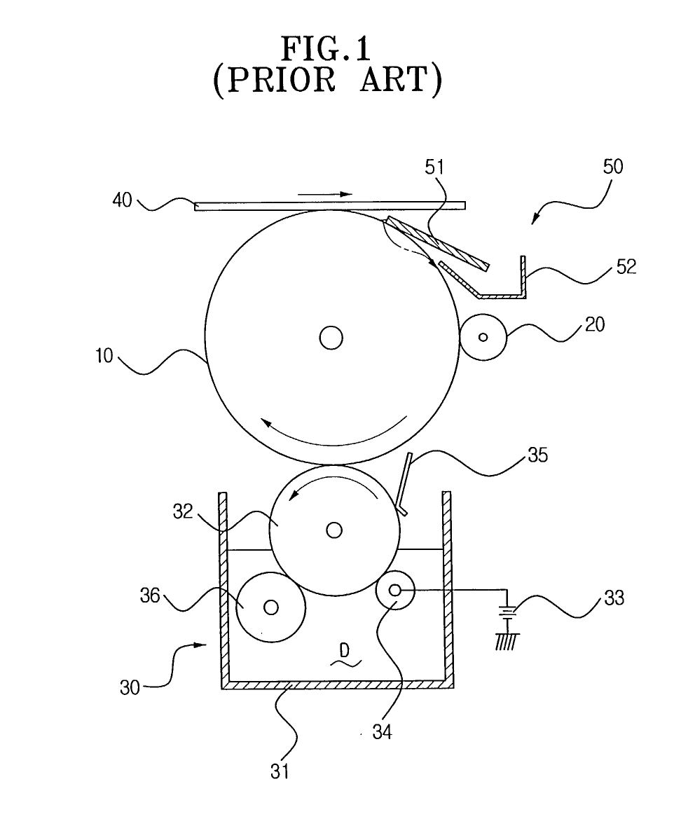

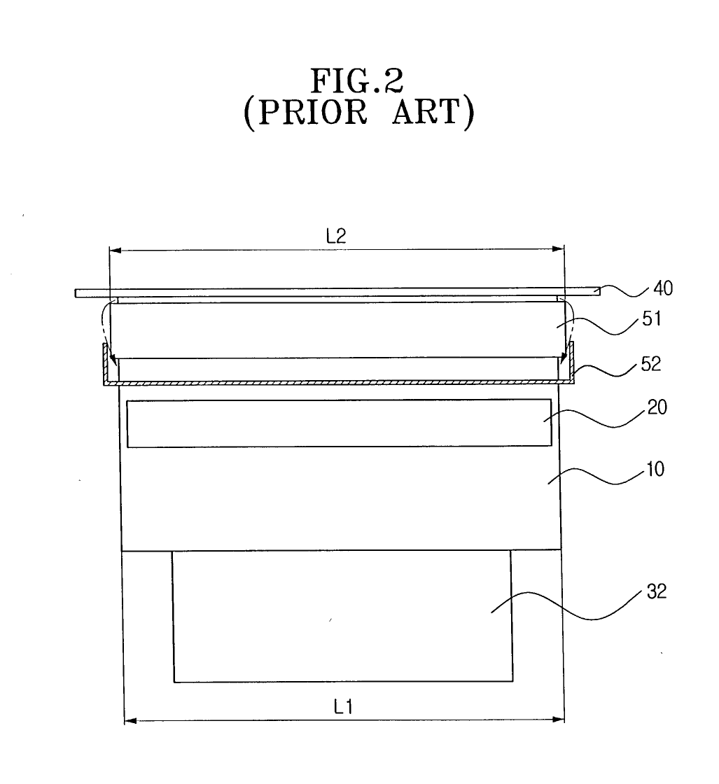

### DETAILED DESCRIPTION OF AN ILLUSTRATIVE, NON-LIMITING EMBODIMENT

Hereinafter, an illustrative, non-limiting embodiment of the present invention will be described with reference to the accompanying drawings. Meanwhile, with respect to the components that have constructions and operation like those of a conventional wet type printer, like reference numerals will be given and the descriptions will be omitted wherever possible.

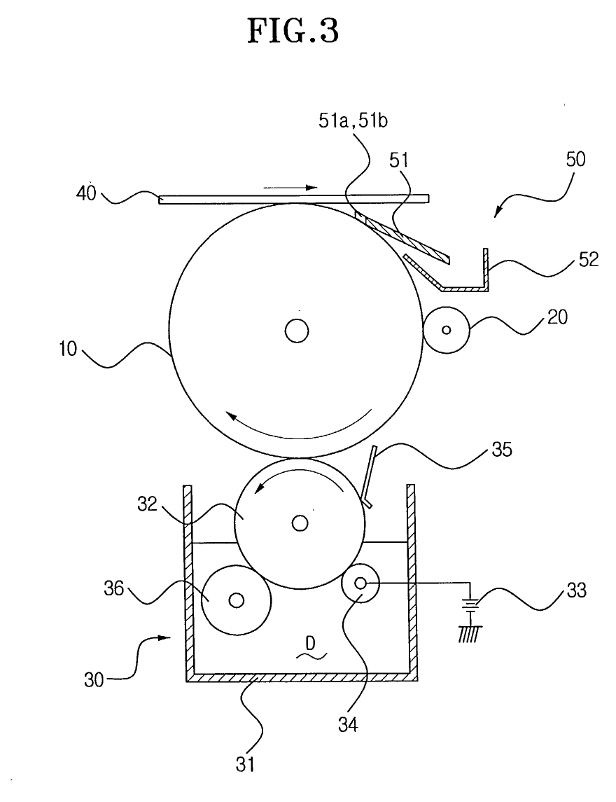

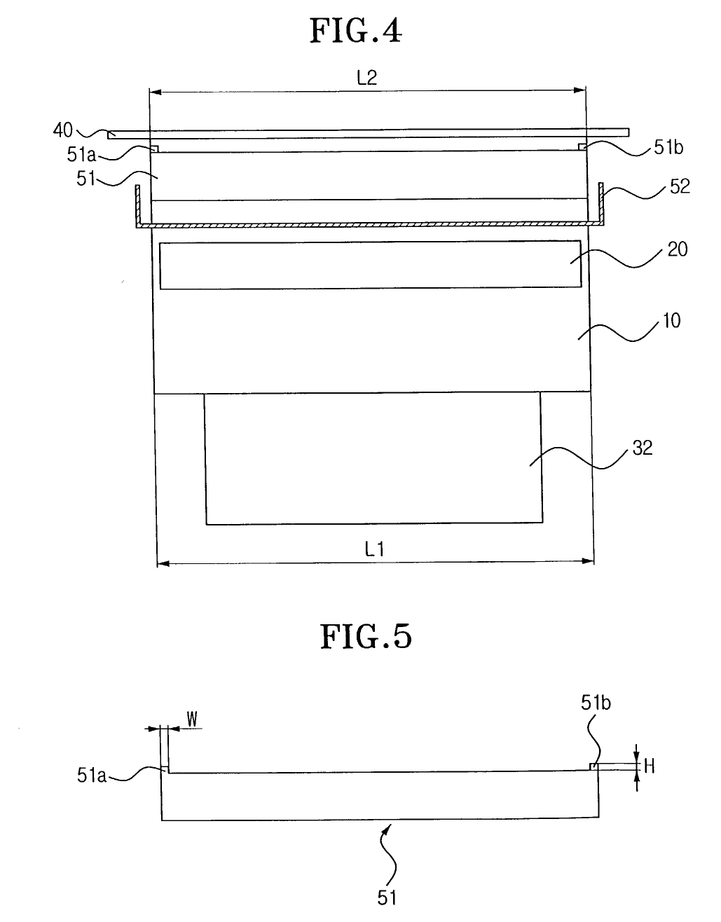

In FIGS. 3 through 5, the reference numerals 10, 20, 30, 40, and 50 respectively indicate a photosensitive drum, a charging roller, a developing device, a transfer belt, and a photosensitive drum cleaning device.

As shown in FIGS. 3 through 5, the photosensitive drum cleaning device 50 of the wet type printer according to the present invention comprises a cleaning blade 51 and a developer drain holder 52.

The cleaning blade 51 is disposed adjacent to a nip of the photosensitive drum 10 and the transfer belt 40 and is inclined by a predetermined angle with respect to the photosensitive drum 10 such that an end of the cleaning blade 51 contacts an outer circumference of the photosensitive drum 10. Accordingly, the cleaning blade 51 wipes the residual developer off from the photosensitive drum 10. The developer drain holder 52 is disposed under the cleaning blade 51, for collecting the developer wiped off from the photosensitive drum 10 by the cleaning blade 51. The developer is finally collected in the developer receptacle 31 of the developing device 30 or discharged externally.

The basic construction of the photosensitive drum cleaning device according to the present invention is similar to that of the conventional photosensitive drum cleaning device; however, the photosensitive drum cleaning device of the present invention is characterized in that the cleaning blade 51 has a pair of guide wings 51a and 51b.

The guide wings 51a and 51b are respectively formed at opposite sides of a contact portion where the cleaning blade 51 contacts the photosensitive drum 10, having a predetermine height H. Due to the presence of the guide wings 51a and 51b, the residual developer wiped off from the photosensitive drum 10 by the cleaning blade 51 does not stream down over the opposite sides of the cleaning blade 51. In the conventional photosensitive drum cleaning device, the developer wiped off from the photosensitive drum 10 by the cleaning blade 51 streams down over both sides of the cleaning blade 51 prior to being accumulated to the extent that corresponds to the thickness of the cleaning blade 51, thereby contaminating the charging roller 20. According to the present invention, the photosensitive drum cleaning device is provided with the pair of guide wings 51a and 51b formed at the opposite sides of the cleaning blade 51, for blocking a flow of the developer, such that the developer does not stream down over the opposite sides of the cleaning blade 51, and is instead accumulated at the contact portion of the photosensitive drum 10 and the cleaning blade 51 to an extent that corresponds to the thickness of the cleaning blade 51. When the developer is accumulated at the contact portion of the photosensitive drum 10 and the cleaning blade 51 to an extent that corresponds to the thickness of the cleaning blade 51, the developer flows over the cleaning blade 51 into the developer drain holder 52.

Each one of the pair of guide wings 51 a and 51b, which are formed at both sides of the cleaning blade 51 of the photosensitive drum cleaning device according to the present invention, has a width W that is thinner than the thickness of the cleaning blade 51. Accordingly, the cleaning blade 51 completely contacts the photosensitive drum 10 without being detached from the photosensitive drum 10.

Preferably, but not necessarily, each of the guide wings 51a and 51b is formed to have a height H to maintain a predetermined gap with respect to the transfer belt 40 and to prevent the developer from streaming down over the opposite sides of the cleaning blade 51.

Also, the cleaning blade 51 having the pair of guide wings 51a and 51b has a length L2 identical to the length L1 of the photosensitive drum 10 or a length L2 shorter than that of the photosensitive drum 10.

Meanwhile, the cleaning blade 51, which has the pair of guide wings 51a and 51b as an aspect of the present invention, is simply moulded as shown in FIG. 5 so that it does not have a loss of material.

According to the present invention as constructed above, the photosensitive drum cleaning device 50 of the wet type printer is provided with the cleaning blade 51 contacting the photosensitive drum 10, for wiping the residual developer off from the rotating photosensitive drum 10. The developer wiped by the cleaning blade 51 is accumulated at the contact portion of the photosensitive drum 10 and the cleaning blade 51. When the developer is accumulated to an extent that is more than the thickness of the cleaning blade 51, the developer flows over the cleaning blade 51 into the developer drain holder 52. The conventional photosensitive drum cleaning device has a problem of the so-called “Wrap-around” as the developer streams down over both open sides of the cleaning blade 51 prior to being accumulated to the extent that corresponds to the thickness of the cleaning blade 51. According to the present invention, the guide wings 51a and 51b are provided at the opposite sides of the cleaning blade 51, for blocking passage of the developer. Accordingly, the developer is prevented from streaming down over both sides of the cleaning blade 51.

According to the present invention, due to the presence of the pair of guide wings 51a and 51b disposed at both sides of the cleaning blade 51 that contact the photosensitive drum 10, the developer wiped by the cleaning blade 51 is prevented from streaming down over both sides of cleaning blade 51. Accordingly, the contamination of the transfer roller 40, which is conventionally generated by the “Wrap around”, is prevented. Since the charge uniformity of the photosensitive drum 10 is maintained, the “Back ground” problem is also prevented. Therefore, the printing quality of the printer is improved.

Although the illustrative, non-limiting embodiment of the present invention has been described, it will be understood by those skilled in the art that the present invention should not be limited to the described embodiment, but various changes and modifications can be made within the spirit and scope of the present invention as defined by the appended claims.

What is claimed is:

1. A photosensitive drum cleaning device of a wet type printer, comprising:
a cleaning blade which is operative to be disposed on a photosensitive drum to contact and wipe an outer circumference of the rotating photosensitive drum, and which removes a developer that has not been transferred to a transfer belt but remains on the photosensitive drum; and
a developer drain holder which collects and discharges the developer removed by the cleaning blade,
wherein the cleaning blade comprises first and second guide wings which are respectively formed at opposite sides of a contact portion of the cleaning blade and the photosensitive drum and which have a predetermined height, and wherein the first and second guide wings prevent the developer that is wiped by the cleaning blade from streaming down over the opposite sides of the cleaning blade.

2. The photosensitive drum cleaning device of claim 1, wherein the cleaning blade has a length identical to a length of the photosensitive drum.

3. The photosensitive drum cleaning device of claim 1, wherein each of the first and second guide wings has a width that is thinner than a thickness of the cleaning blade.
